(19) United States
(12) Patent Application Publication
(10) Pub. No.: US 2022/0332315 A1
(43) Pub. Date: Oct. 20, 2022

(54) METHOD FOR OPERATING A MOTOR VEHICLE

(71) Applicant: Brose Fahrzeugteile SE & Co. Kommanditgesellschaft, Bamberg, Bamberg (DE)

(72) Inventors: Takafumi EGUCHI, Oguchi Niwa Aichi (JP); Ryohei HIGUCHI, Kanagawa (JP); Yoshihiro TSUGE, Okazaki (JP)

(73) Assignee: Brose Fahrzeugteile SE & Co. Kommanditgesellschaft, Bamberg, Bamberg (DE)

(21) Appl. No.: 17/723,016

(22) Filed: Apr. 18, 2022

(30) Foreign Application Priority Data
Apr. 19, 2021 (DE) 10 2021 203 890.5

(51) Int. Cl. B60W 30/095; B60W 30/18; B60W 40/04; B60W 40/105; E05F 15/73; G01S 13/08; G01S 13/931; G01S 15/08; G01S 15/931

(52) U.S. Cl. CPC B60W 30/0956; B60W 30/18036; B60W 40/04; B60W 40/105; E05F 15/73; G01S 13/08; G01S 13/931; G01S 15/08; G01S 15/931; B60W 2420/52; B60W 2420/54; B60W 2554/4041; B60W 2554/80; G01S 2013/9317; G01S 2013/93272

(57) ABSTRACT

A method for operating a motor vehicle, in which an object situated in a sensor region is detected with the aid of a sensor in surroundings of the motor vehicle; A piece of position information relating to the object is created. The position information is retained when the object is moved out of the sensor region, due to a movement of the motor vehicle, the distance of the object to the motor vehicle not increasing. The invention further relates to a motor vehicle and a computer program product.

This nonprovisional application claims priority under 35 U.S.C. § 119(a) to German Patent Application No. 10 2021 203 890.5, which was filed in Germany on Apr. 19, 2021, and which is herein incorporated by reference.

### BACKGROUND OF THE INVENTION

### Field of the Invention

The present invention relates to a method for operating a motor vehicle, a motor vehicle, and a computer program product. The motor vehicle comprises a sensor for detecting an object in surroundings of the motor vehicle.

### Description of the Background Art

Motor vehicles usually include multiple sensors, with the aid of which surroundings of the motor vehicle are monitored for objects. For example, a driver of the vehicle is notified of the distance to the particular object acoustically and/or optically, so that a maneuvering of the motor vehicle is made easier for the driver. It is also known to use sensors to detect an adjustment region of a door of the motor vehicle for the presence of objects, in particular if the door is driven with the aid of an electric motor. If an object is detected in the adjustment region, a movement of the door is interrupted or prevented, so that a collision of the door with the object is avoided.

Capacitive sensors, for example, are used as sensors of this type, with the aid of which the dielectric constant is determined. If the object is situated in the surroundings of the motor vehicle, the dielectric constant is changed compared to an absence of the object. In capacitive sensors of this type, however, a local resolution is comparatively low, so that a targeted maneuvering by the driver of the motor vehicle is not possible. It is also possible that an adjustment of the door is prevented, the object, however, not being situated in the adjustment range of the door, but rather having a short distance therefrom.

Ultrasonic sensors or radar sensor are therefore usually used to increase the local resolution. Waves are emitted with the aid of these sensors, which are reflected and/or scattered on the object, if it is present. These waves are detected with the aid of the sensor, namely a receiver thereof, and the distance of the object to the motor vehicle is ascertained based on the propagation time and/or a change in the waveform. It is also possible to detect the position of the object, in particular, if the sensor includes multiple different sensor units or at least receivers, which are positioned differently.

In principle, the sensor region (detection region) of sensors of this type has an essentially conical shape, only objects situated in the sensor region being detectable. The tip of the cone is formed by the particular receiver of the sensor or the entire sensor. As a result, a region exists in the surroundings of the motor vehicle, which is directly adjacent thereto and abuts it, which, however, is not detectable with the aid of this sensor.

To avoid this, the motor vehicle usually comprises multiple sensors, whose sensor regions overlap, or which are at least arranged in such a way that the portion of the surroundings directly adjacent to the motor vehicle is situated at least in the sensor region of one of the sensors. Since multiple sensors are necessary, the manufacturing costs are also increased. It is also necessary to provide different mounting locations for the sensors, so that a construction and assembly of the motor vehicle is made more difficult.

### SUMMARY OF THE INVENTION

It is therefore an object of the present invention to provide a particularly suitable method for operating a motor vehicle as well as a particularly suitable motor vehicle as well as a particularly suitable computer program product, a safety advantageously being increased and/or manufacturing costs being reduced.

In an exemplary embodiment, the method is used to operate a motor vehicle. The motor vehicle is designed, in particular, to be a land-based and preferably a multi-track vehicle. It is suitably possible to essentially freely position the motor vehicle, in particular on a corresponding roadway. The motor vehicle advantageously has corresponding wheels for this purpose. In summary, it is preferably possible to position the motor vehicle on land essentially regardless of other conditions. In other words, the motor vehicle is suitably not railbound. The motor vehicle is preferably a passenger car or a commercial vehicle, such as a truck or a bus.

The motor vehicle comprises a sensor, which is used to detect an object in surroundings of the motor vehicle. The sensor is suitable, in particular provided and configured, for this purpose. A detection is possible with the aid of the sensor, only if the object is in a sensor region of the sensor. If the object is outside the sensor region, it may not be detected with the aid of the sensor. Since the surroundings of the motor vehicle are situated outside the motor vehicle and surround the latter, the sensor region is directed into the surroundings of the motor vehicle. For example, a portion of an inner area of the motor vehicle is also situated in the sensor region, or the sensor region is preferably arranged only outside the motor vehicle. For example, the sensor region is essentially conical, the sensor being arranged at the tip of the sensor region. The sensor region is preferably rotationally symmetrical, the sensor being advantageously arranged on the axis of symmetry. A construction of the sensor is simplified in this way. In particular, the sensor is rigidly fastened to further components of the motor vehicle, such as its body. For example, the position of the sensor region with respect to the motor vehicle is fixed. A construction is further simplified in this way.

The method provides that an object situated in the sensor region of the sensor is detected with the aid of the sensor. The object is consequently detected in the surroundings of the motor vehicle. For example, the detection takes place when the object enters the sensor region, which occurs, for example, due to a relative movement of the object with respect to the motor vehicle and thus also with respect to the sensor region. Alternatively, the detection takes place when the sensor is activated. It is possible for the object to already be situated comparatively far into the sensor region. In other words, the object is thus detected with the aid of the sensor when the latter is already in the sensor region. The detection is, in particular, the first-time measurement of the object with the aid of the sensor.

Once the object has been detected, a piece of position information relating to the object is created. In other words, the position information relates to the object and is, in particular, preferably created essentially immediately after the first detection/measurement of the object. The position information is preferably used to indicate that the object is situated in the surroundings of the motor vehicle. In addition, the distance of the object to the motor vehicle and its position with respect to the motor vehicle are particularly preferably stored in the position information. The position is stored, for example, in Cartesian coordinates or spherical coordinates, in particular with respect to the sensor.

According to the method, the position information is retained when the object is moved out of the sensor region, this taking place due to a movement of the motor vehicle itself. In other words, the sensor region is reoriented due to the movement of the vehicle, the object no longer being situated in the reoriented sensor region. Also in other words, a direct detection of the object with the aid of the sensor is no longer possible, due to the movement of the motor vehicle. In particular, the movement of the motor vehicle is derived in the basis of a position sensor of the motor vehicle and/or of a setting of a drive of the motor vehicle and/or on the basis of a wheel rotational speed sensor of the motor vehicle.

The position information is retained if the distance of the object to the motor vehicle has not increased, i.e., if the distance of the object upon leaving the sensor region is at most the same as the distance of the object to the motor vehicle upon its detection. In other words, the object is thus situated the same distance from the motor vehicle upon leaving the sensor region as at the point in time upon detection of the object.

Due to the method, therefore, the position information continues to be present, and thus the knowledge that the object is situated in the (closer) surroundings of the motor vehicle, even if it is not directly detectable. Since the distance of the object to the motor vehicle is less than upon its detection, the probability of a collision of the motor vehicle or at least a part thereof with the object is likely. Due to the position information, which continues to be present, a collision may, however, be avoided, so that a safety is increased. A complete monitoring of the surroundings with the aid of the sensor, and thus a corresponding arrangement of the sensor region, is not necessary, so that manufacturing costs are reduced. It is thus possible, in particular, to use a comparatively cost-effective sensor, in which the sensor region, which is also referred to as the detection region, is, for example, only conical or comparatively small in volume/flat.

In summary, it is furthermore possible, since the position information is retained, to warn the driver of the motor vehicle of the object and/or to carry out a further function of the motor vehicle depending on the position information of the object, even if the latter is not directly detectable. The (current) position of the object is advantageously stored in the position information, so that further functions of the motor vehicle may be carried out depending thereon.

For example, the position information is deleted if the distance of the object to the motor vehicles is greater when it leaves the sensor region than upon detection, i.e. upon the creation of the position information. In this case, a collision of the motor vehicle or parts of the motor vehicle with the object is unlikely. A complexity is reduced due to the deletion. In addition, it is not necessary to maintain a comparatively large memory to retain the position information of a multiplicity of objects, which are of little relevance to the motor vehicle.

The position information is particularly preferably retained only if the object has a shorter distance when moving out of the sensor region than upon detection. Consequently, the position information is retained if the object is situated comparatively close to the motor vehicle and, as a result, is situated in a non-monitored area of the surroundings adjacent to the motor vehicle, depending on the design of the sensor region. Due to the reduced distance, an approach of the object to the motor vehicle is given, due to the movement of the motor vehicle, so that a collision with the object is likely. If the distance upon leaving the sensor region is equal to the distance upon detection, the position information is, in particular, deleted. In other words, due to the movement of the motor vehicle, the distance to the object is not changed, so that, upon a further movement of the motor vehicle, a collision of the motor vehicle with the object is also not to be assumed.

Alternatively or in combination herewith, the position information is retained only if the distance to the object is reduced upon a continued movement of the motor vehicle along a current trajectory. In other words, the current trajectory of the motor vehicle is first ascertained, which corresponds to the movement of the motor vehicle, based on which the object has moved/will move out of the sensor region. In particular, it is assumed that the current trajectory will be retained and, in particular, the continued movement direction of the motor vehicle does not change. Alternatively or in combination herewith, the same absolute value of the continued movement speed of the motor vehicle is also assumed. In other words, the position information is retained if a further approach of the motor vehicle to the object is to be assumed. Conversely, the position information is preferably deleted if the distance of the object to the motor vehicle remains the same or increases with the current trajectory, i.e., if the object is not relevant to the motor vehicle.

In particular, the position information is retained only if a collision of the motor vehicle with the object will take place, due to the current trajectory, for example within a particular time period, for example 5 minutes, 3 minutes, 1 minute or 0.5 minutes. Alternatively or in combination herewith, the position information is retained if the object will enter the adjustment region of a positioning drive of the motor vehicle, in particular an electromotive door positioner, due to the current trajectory, i.e. if the motor vehicle continues to move along the current trajectory. As a result, an increased complexity is necessary at first when assessing whether the position information is retained. In the following, however, only the position information of objects is retained, which represent a relevance for the motor vehicle, so that a subsequent complexity is reduced.

Alternatively or in combination herewith, the position information is retained only if the object is stationary. In other words, a classification first takes place as to whether the object is a stationary object. For example, it is checked whether the object is a component of an infrastructure. If the object is not stationary, however, the position information is, in particular, deleted. If the object is designed to be movable and, in particular, moves, it is possible that, if it is no longer detectable with the aid of the sensor, the object moves in relation to the motor vehicle, so that the retained position information is not correct. Since, for example, a function of the motor vehicle is carried out based on the position information, the execution of the function is not comprehensible to the user of the motor vehicle, i.e., in particular, the driver, if the object was moved. In particular, it is not necessary to even carry out the function in this case. Since the position information is deleted in this case, a malfunction of the motor vehicle is avoided, on the one hand, and a storage demand or other hardware resources is/are reduced, on the other hand.

For example, a object which is fixedly anchored to the ground is used as a stationary object. However, (in principle) movable objects are also used as stationary objects, which, however, were not moved while they were in the sensor region. For example, a further parked car is treated as a stationary object. In particular, any object is classified as a stationary object, whose position was absolutely not changed during the time period between the detection and the movement out of the sensor region.

For example, the position information is kept constant if the object was moved out of the sensor region. The position information thus designates the part/point of the sensor region, at which the object was moved out of the sensor region.

The position information particularly preferably continues to be updated as long as the object is in the sensor region. The update advantageously takes place based on the sensor data generated with the aid of the sensor, so that the position information is updated based on the measurement of the position of the object with respect to the motor vehicle.

However, the position information is particularly preferably adapted depending on a vehicle speed. The vehicle speed is ascertained, in particular, based on a position sensor of the motor vehicle and/or a setting of a drive of the motor vehicle and/or a setting of the steering angle of the motor vehicle, and is received, for example, via a bus system. Alternatively, the vehicle speed is derived, based on one or multiple reference positions detected with the aid of the sensor.

For example, the adaptation takes place while the object is still within the sensor region. In this case, the object is not re-detected, for example with the aid of the sensor, so that an energy demand for operating the sensor is reduced. Alternatively, the sensor is only periodically operated, and the position information is adapted based on the vehicle speed in the phases of non-operation. However, it is particularly preferred to essentially continuously detect the object with the aid of the sensor as long as the object is in the sensor region.

Once the object has left the sensor region, the position information is, in particular, adapted depending on the vehicle speed. The position information is adapted, in particular, depending on the absolute value of the vehicle speed and/or depending on a current continued movement direction, i.e. the vectorial component of the vehicle speed. In other words, the position information is adapted based on the current movement of the motor vehicle, i.e., in particular, based on its current trajectory. In other words, the position information corresponds to the assumption of where the object is currently located with respect to the motor vehicle. It is advantageously assumed that the object is stationary. Alternatively, an intrinsic movement of the object, in particular, is taken into account, if the latter is not stationary. In other words, the position information is additionally modified depending on a trajectory of the object when leaving the sensor region. It is preferably assumed that the intrinsic movement of the object is constant.

For example, the position information is adapted, depending on the vehicle speed, until the object is again detectable with the aid of the sensor, i.e., until it again enters the sensor region. From that point on, an adaptation of the position information advantageously takes place based on the measurement data, i.e., by measuring the object. In one refinement, the position information is deleted if the distance of the object to the motor vehicle ascertained based on the position information is greater than a further limit value. The further limit value is, for example, 5 m, 10 m, 20 m or 50 m. At such a distance, a relevance of the object for the motor vehicle is essentially not given, and resources in the motor vehicle are released, based on the deletion.

For example, the position information is represented in a map, which is displayed in an interior of the motor vehicle. A particular function of the motor vehicle is preferably carried out depending on the position information, for example the output of a notification/warning and/or the warning of a user of the motor vehicle. The notification/warning is output acoustically and/or visually. The function is advantageously carried out if a distance of the object to the vehicle derived based on the position information drops below a certain limit value. In particular, the function is carried out regardless of whether the object is directly detectable with the aid of the sensor at the point in time at which the function is carried out and is thus within the sensor region. In other words, to check whether the limit value is undershot, the position information is always used, regardless of whether it was ascertained directly based on the sensor or otherwise, for example by derivation based on further parameters, such as the adaptation based on the vehicle speed.

The motor vehicle can comprise an electromotive door positioner. The electromotive door positioner includes a door driven with the aid of an electric motor, which is supported on a vehicle body of the motor vehicle, for example in a pivotable and/or longitudinally movable manner. For example, the door is a side door or a hatch. The electric motor is, for example, a brush-type commutator motor or, for example a brushless DC motor (BLDC). In particular, a transmission, such as a worm wheel transmission, is driven with the aid of the electric motor. A component, variable in length, such as a spindle, which is advantageously supported on the door, is advantageously driven with the aid of the electric motor, preferably via the transmission. During the operation of the electric motor, the door is suitably moved along the adjustment path, in particular, between a completely closed and a completely open position.

An adjustment path of the electromotive door positioner can be set by carrying out the function. In other words, the adjustment path of the electromotive door positioner is set depending on the position information. The adjustment path is set and advantageously shortened depending on the position information. In particular, the adjustment path is adapted in such a way that a collision with the object is prevented, which is derived on the basis of the position information. For example, during the setting, the adjustment path is reduced to a particular value or set entirely to zero (0), so that an adjustment is completely prevented. In summary, the electromotive door positioner is operated depending on the position information. In one refinement, the warning/notification is also output, so that the reason why the adjustment path was adapted is apparent to a user of the motor vehicle.

For example, the door is moved along the set adjustment path when a corresponding prompt to operate the electromotive door positioner is present. The prompt is generated, for example, by a user of the motor vehicle, for example the driver, or based on an on-board computer of the motor vehicle.

A sensor can be used in the method, whose sensor region is situated in a longitudinal direction behind the motor vehicle. In other words, it is possible, with the aid of the sensor, to monitor a region located behind the motor vehicle, if the latter is moved as intended. As a result, during a reverse maneuvering of the motor vehicle, the motor vehicle is moved in the direction of the sensor region. For example, the sensor is fastened on a rear bumper or at least in the region of a rear bumper of the motor vehicle.

For example, the sensor is always active. However, the sensor is particularly preferably activated only at the beginning of a reverse travel of the motor vehicle. The activation preferably takes place as soon as a reverse gear of the motor vehicle is engaged, or only when an actual movement of the motor vehicle takes place, i.e., when the latter is at least partially moved backwards, in particular, in the longitudinal direction. At the beginning of the reverse travel, the sensor is used to monitor whether the object is in the sensor region. For example, the sensor is deactivated once the reverse travel of the motor vehicle has ended and, for example, a forward gear has been engaged. However, the sensor particularly preferably remains active after being activated during the maneuver, which comprises the reverse travel. In particular, the maneuver is ended as soon as the motor vehicle is stopped or as soon as the motor vehicle is again moved forward in the longitudinal direction, the speed exceeding a particular limit speed, for example 30 km/h. Since the sensor is not always active, an energy demand is reduced. Since the motor vehicle also approaches an object situated behind the motor vehicle only during a reverse travel, any other approach of the motor vehicle toward the object is essentially also excluded in this case.

In particular, a sensor is used as the sensor, with the aid of which waves are emitted during operation, which are scattered and/or reflected on the object if the latter is present. The waves reflected/scattered in this manner are moved at least partially in the direction of the sensor, where they are received with the aid of the sensor. In particular, the sensor includes a suitable transmitter for emitting the waves as well as a suitable receiver for reception. For example, the transmitter and the receiver are implemented with the aid of a common structural unit or with the aid of two components spaced a distance apart. Due to the use of waves, the sensor region is, in particular, conical. For example, the sensor includes multiple receivers, so that a local resolution of the sensor is improved. The receiving region is not only conical but also has multiple conical sections, due to the plurality of receivers. However, the surroundings also comprise other regions, which are not part of the sensor region, and which, however, abut the motor vehicle.

For example, a radar sensor is used as the sensor, so that the waves are radar waves. Alternatively, an ultrasonic sensor is used as the sensor, so that the waves are ultrasonic waves. By selecting waves in this manner, a comparatively precise local resolution is made possible. For example, the sensor comprises the radar sensor or the ultrasonic sensor, and the sensor suitably includes multiple sensor units, for example multiple of the sensor units each being radar sensors and/or ultrasonic sensors.

Due to the method, an improved, precise monitoring of the surroundings for the object is made possible despite the comparatively close-meshed monitoring with the aid of the multiple sensor units/receivers, even if the object is not directly detectable. In other words, if the object is moved out of the sensor region, which is determined with the aid of the multiple sensor units/receivers, the position information according to the method continues to be retained.

The motor vehicle is, in particular, land-based, for example a truck, bus or preferably a passenger car. The motor vehicle comprises a sensor having a sensor region. During operation, it is possible to detect an object with the aid of the sensor, which is situated in the sensor region. If the object is not in the sensor region, however, a detection of the object is not possible. The sensor is thus used to detect the object and is suitable as well as provided and configured for this purpose. The sensor region is, in particular, a component of the surroundings, so that the surroundings are monitored with the aid of the sensor. In other words, the sensor region is directed outwardly away from the motor vehicle. The sensor is preferably an ultrasonic sensor or a radar sensor or comprises at least one thereof. The sensor suitably includes multiple different sensor units, one of the sensor units being, for example, the ultrasonic sensor and another sensor unit being the radar sensor. In particular, a fusion of sensor data of different sensor units takes place with the aid of the sensor.

The motor vehicle is operated according to a method, in which, in the surroundings of the motor vehicle, an object situated in the sensor region is detected with the aid of the sensor, and a piece of position information relating to the object is created. The position information is retained when the object is moved out of the sensor region, due to a movement of the motor vehicle, the distance of the object to the motor vehicle not increasing.

The motor vehicle includes, in particular, a control unit, which is suitable, in particular provided and configured, to carry out the method. The control unit comprises, for example, an application-specific circuit (ASIC) or particularly preferably a computer, which is suitably designed to be programmable. In particular, the control unit comprises a storage medium, on which a computer program products is stored, which is also referred to as a computer program, the computer being prompted to carry out the method when this computer program product, i.e. the program, is executed. Additional tasks are preferably taken on with the aid of the control unit. One task of this type is, for example, the evaluation of the objects detected with the aid of the sensor unit. Alternatively or in combination herewith, the control unit is a component of an electromotive door positioner, which comprises a door driven with the aid of an electric motor, which is supported on a vehicle body of the motor vehicle in a pivotable and/or longitudinally movable manner.

The computer program product comprises a number of commands which, when the program (computer program product) is executed by a computer, prompt the latter to carry out a method for operating a motor vehicle, which includes, in particular, a sensor having a sensor region for detecting an object in surroundings. An object situated in the sensor region is detected in the surroundings of the motor vehicle with the aid of the sensor, and a piece of position information relating to the object is created. The position information is retained when the object is moved out of the sensor region, due to a movement of the motor vehicle, the distance of the object to the motor vehicle not increasing.

The computer is advantageously a component of a control unit or electronic system and is formed, for example, with the aid thereof. The computer preferably comprises a microprocessor or is formed with the aid thereof. The computer program product is, for example, a file or a data medium, which contains an executable program, which automatically carries out the method when installed on a computer.

The invention further relates to a storage medium, on which the computer program product is stored. A storage medium of this type is, for example, a CD-ROM, a DVD or a Blu-ray disk. Alternatively, the storage medium is a USB stock or another memory, which is, for example, a rewritable or WORM device. A memory of this type is, for example, a flash memory, a RAM or a ROM.

The invention also relates to a control unit for carrying out the method, which is thus suitable, in particular provided and configured, for this purpose. The control unit includes, for example, a application-specific circuit (ASIC) for this purpose or, for example, a programmable microprocessor, which acts, in particular, as a computer. The control unit suitably comprises a storage medium, on which the computer program described above is stored.

The refinements and advantages explained in connection with the method are transferred similarly to the computer program product/storage medium/motor vehicle/control unit and among each other as well as vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a motor vehicle, including a sensor and an electromotive door positioner;

FIG. 2 shows a method for operating the motor vehicle; and

FIGS. 3 through 6 each schematically show a top view of the motor vehicle during the method.

### DETAILED DESCRIPTION

FIG. 1 shows a schematically simplified view of a motor vehicle 2 in the form of a passenger car. Motor vehicle 2 has four wheels 4, with the aid of which a contact with a roadway takes place. Wheels 4 are connected to a vehicle body 6 of the motor vehicle via a chassis and a portion of wheels 4 is driven with the aid of a main drive. At least two of wheels 4 are also designed to be steerable and a component of a steering system, so that a continued movement direction of motor vehicle 2 may be set. Two of the total of four wheels 4 are arranged one behind the other in a longitudinal direction 8 in each case, motor vehicle 2 being moved (forward) in longitudinal direction 8 in a state for which it is intended. This takes place when steerably designed wheels 4 are in a neutral position, and the main drive is operated in the forward direction. In other words, longitudinal direction 8 corresponds to the orientation of motor vehicle 2, and seats of motor vehicle 2 are oriented in longitudinal direction 8 (toward the front).

Motor vehicle 2 comprises an electromotive door positioner 10, which includes a door 12, which is pivotably movably supported on vehicle body 6 with the aid of a hinge 14. Door 12 is a hatch, and electromotive door positioner 10 is thus an electromotive hatch. Electromotive door positioner 10 comprises an electric motor 16, which is operatively connected to door 12 via a transmission as well as a spindle. When power is supplied to electric motor 16, door 12 is moved along an adjustment path 18, which is at least partially curved, due to hinge 14. In other words, door 12 is pivoted with respect to vehicle body 6. Adjustment path 18 extends from a completely closed position of door 12 to a completely open position of door 12. Door 12 is opened or closed, depending on the rotational direction of electric motor 16.

Motor vehicle 2 also includes a sensor 20, which has a sensor region 22. Sensor 20 is situated below door 12 in the vertical direction in the region of a lower bumper of motor vehicle 2. Sensor region 22 is the region, in which an object 24 is detectable with the aid of sensor 20. However, if object 24 is outside sensor region 22, a detection of object 24 is not possible. Sensor region 22 is directed outwardly from motor vehicle 2 into surroundings 23. In other words, sensor 20 is used to detect object 24 in surroundings 23 of motor vehicle 2, i.e., outside motor vehicle 2. Sensor region 22 is situated behind motor vehicle 2 in longitudinal direction 8, so that object 24 may be detected with the aid of sensor 20 only if it is situated behind motor vehicle 2 in longitudinal direction 8.

The shape of sensor region 22 is conical, sensor 20 being arranged at the tip of the cone. The axis of the cone is tilted slightly upward with respect to a horizontal. Due to the tilting, it is possible with the aid of sensor 20 to detect object 24, even if it is situated comparatively far above sensor 20, no limitation with respect to object 24 being present, due to the comparatively short distance of sensor 20 to the roadway if the object is arranged comparatively deep in the vertical direction.

During the operation of sensor 20, waves are reflected and/or scattered thereby on object 24, provided it is situated in sensor region 22, and are emitted with the aid of a transmitter. A portion of the reflected/scattered waves strikes sensor 20 from sensor region 22, where they are detected with the aid of a receiver. Based on the time difference between the emission of the waves and the receipt of the waves, it is possible to ascertain the distance of object 24 to motor vehicle 2 and possibly also its position with respect to motor vehicle 2.

Sensor 20 may be a radar sensor or an ultrasonic sensor. The waves emitted with the aid of sensor 20 are thus either radar waves or ultrasonic waves, and the transmitter and receiver of sensor 20 are correspondingly adapted to the type of waves used in each case. sensor 20 can include multiple receivers, so that a local resolution is improved. In a further variant, sensor 20 may include multiple different sensor units, each of the sensor units being, for example, a radar sensor or an ultrasonic sensor. In a further alternative, at least one of the sensor units is a radar sensor and at least one of the other sensor units is an ultrasonic sensor.

Motor vehicle 2 includes a control unit 26, which is connected via signals to electromotive door positioner 10 and sensor 20. For example, electromotive door positioner 10 and/or sensor 20 is/are operated entirely with the aid of control unit 26, or only certain presets are transmitted to electromotive door positioner 10 and/or sensor 20 with the aid of control unit 26, control signals for electric motor 16 and/or the transmitter of sensor 20 being generated, based on the presets, with the aid of a corresponding control device of electromotive door positioner 10 or sensor 20.

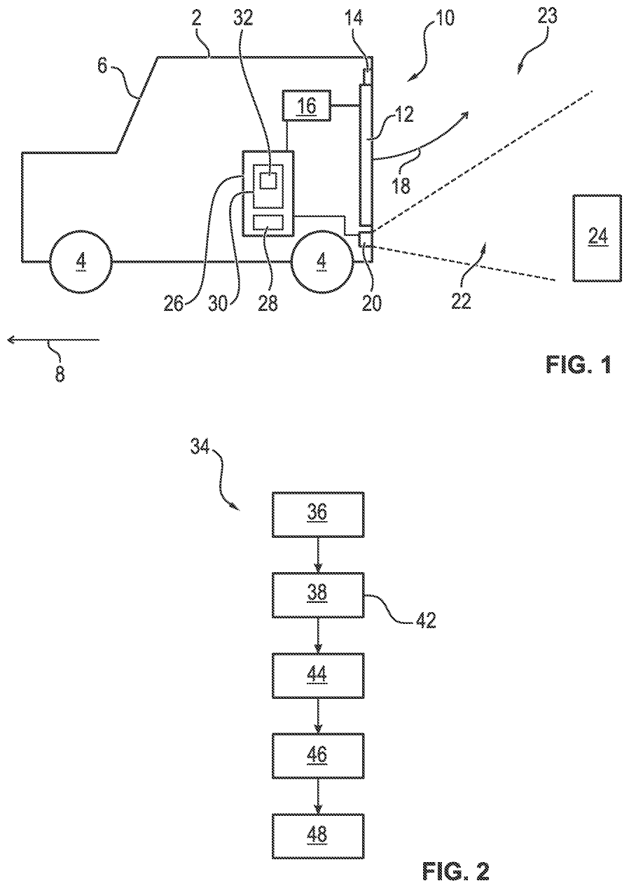

Control unit 26 includes a computer 28 in the form of a programmable microprocessor. Control unit 26 also comprises a storage medium 30 in the form of a memory, on which a computer program product 32 is stored. Computer program product 32 comprises multiple commands, which, when the program is executed by computer 28, prompt the latter to carry out a method 34 illustrated in FIG. 2 for operating motor vehicle 2. In other words, motor vehicle 2, which includes sensor 20 for detecting object 24 in surroundings 23, is operated according to method 34.

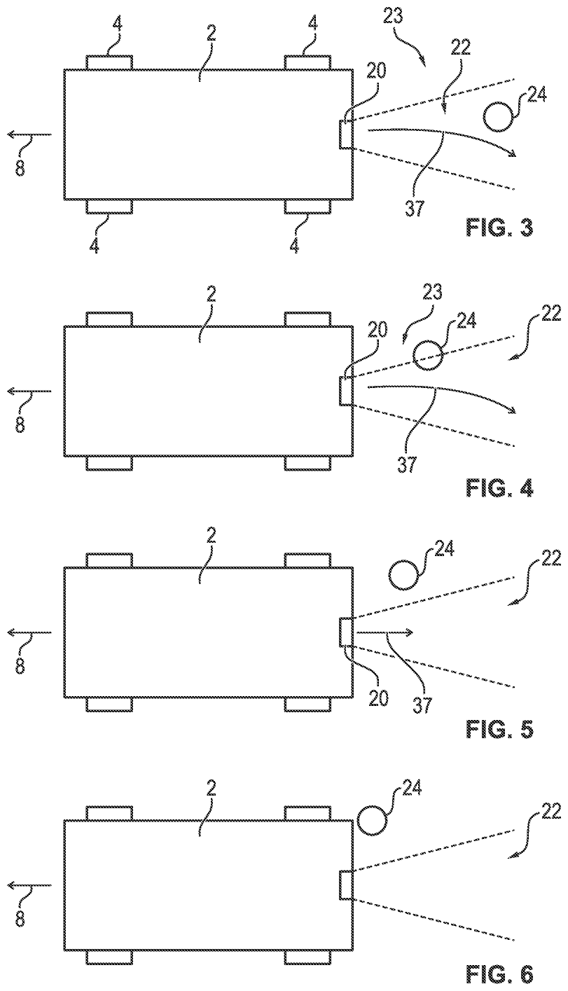

In a first work step 36, sensor 20 is activated, so that waves are emitted into sensor region 22 with the aid of sensor 20. First work step 36 is carried out at the beginning of a reverse travel of motor vehicle 2. In other words, sensor 20 is activated when motor vehicle 2 begins to reverse, and the waves thus strike sensor region 22. Due to the reverse travel of motor vehicle 2, which is illustrated in a schematically simplified manner in a top view in FIG. 3, i.e., from the birds-eye perspective, the vehicle is moved along a current trajectory 37. Due to the reverse travel, this is oriented against longitudinal direction 8, i.e., toward the back in longitudinal direction 8. Current trajectory 37 is also slightly curved in this example, due to a steering angle of steerably designed wheels 4.

In a subsequent second work step 38, object 24 is detected when it is situated in sensor region 22, i.e. is part of surroundings 23 of motor vehicle 2. The detection takes place based on the registration/detection/measurement of the waves reflected/scattered on object 24. In other words, the position of object 24, and thus its presence, is measured with the aid of sensor 20. Once object 24 has been detected, a piece of position information 42 relating to object 24 is created. At least the distance of object 24 to motor vehicle 2 is stored in position information 42 and, in a farther-reaching variant, also the position of object 24 with respect to the motor vehicle. During the movement of motor vehicle 2 along current trajectory 37, object 24 moves with respect to motor vehicle 2, which is detected due to the continued operation of sensor 20. An update of position information 42 takes place, based on the measurement data generated with the aid of sensor 20.

In a third work step 44, the fact that object 24 leaves sensor region 22 due to the movement of motor vehicle 2 along current trajectory 37 is detected, as illustrated in FIG. 4. Object 24 is moved out of sensor region 22, due to the movement of motor vehicle 2 along current trajectory 37. In the illustrated example, the distance of motor vehicle 2 to object 24 is reduced, sensor region 22 also being pivoted. As a result, object 24 enters a region of surroundings 23, which is situated behind vehicle 2 in longitudinal direction 8, which however, is not in sensor region 22. After third work step 44, a direct detection of object 24 with the aid of sensor 20 is thus no longer possible.

Based on position information 42 while object 24 is being detected and when it leaves sensor region 22, the extent to which object 24 is laterally offset with respect to a longitudinal axis of motor vehicle 2 is also derived in third work step 44. This is also stored in position information 42. The storage of the corresponding offset is already carried out in second work step 38, i.e., during the update of position information 42 while object 24 is still in sensor region 22. This also takes place only if the complete position of object 24 with respect to motor vehicle 2 is not already also stored in position information 42.

In third work step 44, it is checked whether certain conditions are present. It is thus checked whether object 24 is stationary, i.e., whether it has moved with respect to the stationary roadway between second work step 38 and third work step 44, or whether the relative movement with respect to motor vehicle 2 took place as a result of the movement of motor vehicle 2 itself. It is also checked whether the distance of object 24 to motor vehicle 2 has a shorter distance in third work step 44, i.e. when leaving sensor region 22 than when it is detected in second work step 38. In other words, it is thus checked whether object 24 has a shorter distance when leaving sensor region 22, due to the movement of motor vehicle 2, than upon detection, so that the distance of object 24 to motor vehicle 2 has not increased between the second and third work steps 38, 44. It is additionally checked whether the distance to object 24 would continue to be reduced with a continued movement of motor vehicle 2 along current trajectory 37.

If one of these conditions is not met, position information 42 is deleted, and method 34 is ended. A fourth work step 46 is otherwise carried out, in which position information 42 is retained, even though object 24 is no longer directly detectable with the aid of sensor 20. In other words, position information 42 is retained when object 24 is moved out of sensor region 22 due to the movement of motor vehicle 2, the distance of object 24 to motor vehicle 2 not being increased, namely if object 24 has a shorter distance during the movement out of sensor region 22 than upon detection. In addition, the distance to object 24, which is stationary, is reduced with a continued movement of motor vehicle 2 along current trajectory 37. During the further movement of motor vehicle 2, retained position information 42 is adapted depending on current trajectory 37, i.e., depending on the vehicle speed of the motor vehicle, which has a vectorial component as well as an absolute value.

In the example illustrated in FIG. 5, the steering angle of steerable wheels 4 have been changed to the neutral position, so that motor vehicle 2 is moved in a straight line against longitudinal direction 8. This is taken into account based on the vehicle speed, so that position information 42 is correspondingly adapted to the now changed current trajectory 37.

In a fifth work step 48, a function of motor vehicle 2 is carried out. The function is carried out depending on position information 42, which relates to the position of object 24, the position of object 24 itself not being directly detectable with the aid of sensor 20. The function can be carried out when the distance of object 24 to motor vehicle 2 drops below a limit value, which is, for example, 30 cm, as illustrated in FIG. 6. In the illustrated example, an emergency brake assistant is actuated as the function, so that the movement of motor vehicle 2 is interrupted. Alternatively or in combination herewith, a notification is output to an interior of motor vehicle 2, so that the driver of motor vehicle 2 is notified of the impending collision with object 24.

In one alternative, the function is also carried out if motor vehicle 2 is stopped by the driver, regardless of whether a warning is issued or motor vehicle 2 was stopped by emergency brake assistant. In other words, the function is also always carried out depending on position information 42. In the illustrated example, adjustment path 18 of electromotive door positioner 10 is set depending on position information 42. Adjustment path 18 is shortened in such a way that a collision of door 12 with object 24 is avoided during the adjustment along adjustment path 18. If electromotive door positioner 10 is subsequently activated, for example, depending on a user input, such as the actuation of a switch in an interior of the motor vehicle or due to a preset of an on-board computer of motor vehicle 2, door 12 is first moved out of the completely closed position along adjustment path 18. Due to the shortening of adjustment path 18, electric motor 16 is already shut down when door 12 has not yet reached the completely open position, but has approached the assumed position of object 24, which is stored in position information 42, by 10 cm. In this case as well, a corresponding warning for the driver of the motor vehicle is output.

The invention is not limited to the exemplary embodiment described above. Instead, other variants of the invention may be derived herefrom by those skilled in the art without departing from the subject matter of the invention. Moreover, in particular, all individual features described in connection with the exemplary embodiment may also be otherwise combined with each other without departing from the subject matter of the invention.

What is claimed is:

1. A method for operating a motor vehicle, the method comprising:
detecting an object situated in a sensor region with the aid of a sensor in a surrounding of the motor vehicle;
creating a piece of position information relating to the object; and
retaining the position information when the object is moved out of the sensor region due to a movement of the motor vehicle, wherein a distance of the object to the motor vehicle is not increasing.

2. The method according to claim 1, wherein the position information is retained only if the object has a shorter distance when moving out of the sensor region than upon detection.

3. The method according to claim 1, wherein the position information is retained only if the distance to the object is reduced during a continued movement of the motor vehicle along a current trajectory.

4. The method according to claim 1, wherein the position information is retained only if the object is stationary.

5. The method according to claim 1, wherein the position information is adapted depending on a vehicle speed.

6. The method according to claim 1, wherein an adjustment path of an electromotive door positioner is set depending on the position information.

7. The method according to claim 1, wherein a sensor is used, whose sensor region is in a longitudinal direction behind the motor vehicle, the sensor being activated at the start of a reverse travel of the motor vehicle.

8. The method according to claim 1, wherein a radar sensor or an ultrasonic sensor is the sensor.

9. A motor vehicle comprising: a sensor having a sensor region to detect an object in a surrounding of the motor vehicle, the sensor being operated according to the method according to claim 1.

10. A computer program product comprising commands, which, when the program is executed by a computer, causes the computer to carry out the method according to claim 1.
